(19) United States
(12) Patent Application Publication
(10) Pub. No.: US 2021/0383640 A1
(43) Pub. Date: Dec. 9, 2021

(54) POWER SYSTEM AND METHOD OF OPERATION THEREOF

(71) Applicant: Mark Sabti, Troy, MI (US)

(72) Inventor: Mark Sabti, Troy, MI (US)

(21) Appl. No.: 17/336,643

(22) Filed: Jun. 2, 2021

Related U.S. Application Data
(60) Provisional application No. 63/033,863, filed on Jun. 3, 2020.

(51) Int. Cl. G07F 17/32; G06F 1/26; H02J 3/38

(52) U.S. Cl. CPC G07F 17/3204; G06F 1/263; H02J 2310/60; H02J 2300/24; H02J 3/381

(57) ABSTRACT

A machine. The machine includes at least one displays and at least one user input devices for operating the machine. The machine further includes a hybrid power system having at least one first power source and a second power source. The at least one first power source and/or the at least one second power source are used to provide the machine with the power needed to operate the machine. The present disclosure also relates to various methods of operating the hybrid power system that: reduces the strain on the power grid by the machine, reduces the power consumption of the machine, reduces the overall costs associated with the operation of the machine, and/or makes the hybrid power system adaptive to the machine and/or the individual user.

### CROSS-REFERENCE TO RELATED APPLICATION

The present application claims the benefit to U.S. Provisional Patent Application Ser. No. 63/033,863, filed Jun. 3, 2020, which is incorporated herein by reference in its entirety.

### FIELD OF THE DISCLOSURE

The present disclosure relates to a power system and a method of operating the power system.

### BACKGROUND OF THE DISCLOSURE

Various power sources are known in the art. The problem with conventional power sources, for example those used to power gambling machines such as slot machines, is that they provide a continuous amount of power to the machine twenty-four hours a day seven days a week. As a result, this results is a large drain on the power grid and substantial power bills to the owner which is undesirable.

It would therefore be advantageous to develop a power system that reduces the drain or strain on the power grid and reduces the overall power consumption by a machine. Additionally, it would be advantageous to develop a power system that aids in reducing the overall costs associated with the operation of a machine such as but not limited to an interactive machine. Furthermore, it would be advantageous to develop a power system that is adaptive to the machine to reduce the overall power consumption and costs associated with the use of the machine.

### SUMMARY OF THE DISCLOSURE

The disclosure relates to a machine, such as but not limited to, an interactive machine (e.g. gambling machine, an arcade game, a vending machine, an automatic teller machine (ATM), and the like, etc.). The machine includes at least one user interface and at least one user input devices for operating the machine. The machine further includes a hybrid power system having at least one first power source and at least one second power source. The at least one first power source and/or the at least one second power source may be used to provide the machine with the power needed to operate the machine. The present disclosure also relates to various methods of operating the hybrid power system that: reduces the strain on the power grid by the machine, reduces the power consumption of the machine, reduces the overall costs associated with the operation of the machine, and makes the hybrid power system adaptive to the machine and/or the user.

In an embodiment, a machine, comprises: at least one user interface; at least one user input device configured to permit a user to interact with the machine; and a power system having at least one first power source and at least one second power source, wherein at least one of the at least one first power source and the at least one second power source is configured to provide power to the machine.

As aspects of certain embodiments, the machine is one of a gambling machine, a casino game machine, a video poker machine, a slot machine, a video slot machine, a gambling kiosk machine, a redemption machine, a note breaker machine, a video gambling machine, an arcade machine, an arcade game machine, a kiosk machine, a vending machine, and an automated teller machine.

As aspects of certain embodiments, the machine further comprises a control unit.

As aspects of certain embodiments, the control unit of the machine is in communication with at least one of a main controller and a cloud based control unit.

As aspects of certain embodiments, the machine further comprises at least one of at least one audible device, at least one visual indicator, at least one article dispensing device, an article generator, an article dispenser, a coin dispenser, and at least one receiving device.

In another embodiment, a method of operation of a machine, comprises: providing a machine including at least one user interface and a power system, the power system including at least one first power source and at least one second power source; supplying the machine with an amount of power from the at least one first power source; and supplying the at least one first power source with an amount of power from the at least one second power source to recharge the at least one first power source.

As aspects of certain embodiments, the at least one first power source is at least one of at least one electro-chemical cell, at least one battery, at least one rechargeable battery, at least one lithium-ion battery, at least one secondary cell, and at least one rechargeable device.

As aspects of certain embodiments, the at least one second power source is at least one of at least one solar power source and an electrical grid.

As aspects of certain embodiments, the method further comprises identifying an amount of power within the at least one first power source.

As aspects of certain embodiments, the method further comprises supplying the machine with an amount of power from the at least one second power source.

As aspects of certain embodiments, the method further comprises monitoring a power within the at least one first power source.

As aspects of certain embodiments, the method further comprises discontinuing supplying the machine with the amount of power from the at least one first power source once the power within the at least one first power source is below a pre-determined level.

As aspects of certain embodiments, the method further comprises discontinuing supplying the at least one first power source with the amount of power from the at least one second power source once the at least one first power source is supplied with a pre-determined amount of power.

As aspects of certain embodiments, the method further comprises operating the machine for a pre-determined amount of time using only the at least one first power source.

As aspects of certain embodiments, the method further comprises determining a percentage of power provided by the at least one first power source to power the machine.

As aspects of certain embodiments, the method further comprises determining a percentage of power provided by the at least one second power source to power the machine.

As aspects of certain embodiments, the method further comprises supplying the machine with an amount of power based on the percentage of power provided by the at least one first power source and the percentage of power provided by the at least one second power source.

In yet another embodiment, a method of operation of a machine, comprises: providing a machine including at least one user interface and a power system, the power system including at least one first power source and at least one second power source; determining if the machine is in one of a high power mode and a low power mode; entering into one of the high power mode and the low power mode; supplying the machine with power from the at least one first power source when the machine is in the low power mode; and supplying the machine with power from the at least one second power source when the machine is in the high power mode.

As aspects of certain embodiments, the method further comprises monitoring an amount of power within the at least one first power source.

As aspects of certain embodiments, the method further comprises determining if the machine should be one of switched from the low power mode to the high power mode and switched from the high power mode to the low power mode.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 is a schematic perspective front view of a machine having a hybrid power system according to an embodiment of the disclosure;

FIG. 2 is a schematic perspective rear view of the machine with the hybrid power system according to an embodiment illustrated in FIG. 1 of the disclosure;

FIG. 3 is a flow-chart illustrating a method of operation the machine and the hybrid power system illustrated in FIGS. 1 and 2 of the disclosure according to an embodiment of the disclosure;

FIG. 4 is a flow-chart illustrating a method of operation the machine and the hybrid power system illustrated in FIGS. 1 and 2 of the disclosure according to an alternative embodiment of the disclosure;

FIG. 5 is a flow-chart illustrating a method of operation the machine and the hybrid power system illustrated in FIGS. 1 and 2 of the disclosure according to another embodiment of the disclosure; and

FIG. 6 is a flow-chart illustrating a method of operation the machine and the hybrid power system illustrated in FIGS. 1 and 2 of the disclosure according to yet another embodiment of the disclosure.

### DETAILED DESCRIPTION OF THE DISCLOSURE

It is to be understood that the subject matter may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

It is within the scope of this disclosure and as a non-limiting example that the hybrid power system may be used in industrial, casino, restaurant, bar, arcade, military, medical, non-medical, and/or personal use type applications. Additionally, it is within the scope of this disclosure and as a non-limiting example that the method of operating the hybrid power system may be used in industrial, casino, restaurant, bar, arcade, military, medical, non-medical, and/or personal use type applications.

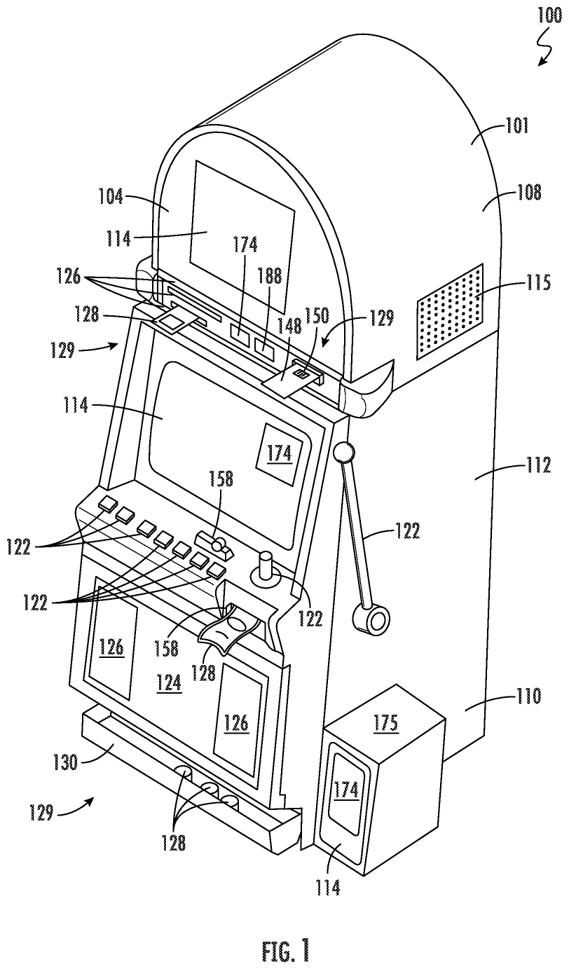

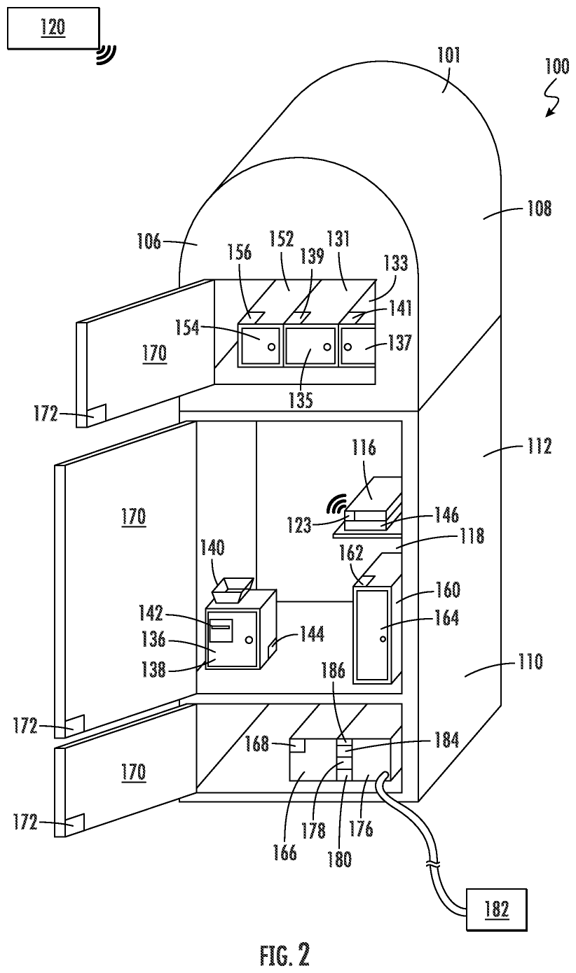

FIGS. 1 and 2 provide a schematic illustration of an interactive machine 100 having a hybrid power system 102 according to an embodiment of the disclosure. It is within the scope of this disclosure and as a non-limiting example that the interactive machine 100 may be any machine that is in operation a significant amount of time (e.g. twenty-four (24) hours a day, seven (7) days per week). As illustrated in FIGS. 1 and 2 of the disclosure and as a non-limiting example, the interactive machine 100 has a housing 101 with a front portion 104, a rear portion 106, a top portion 108, a bottom portion 110, and an intermediate portion 112 interposed between the top and bottom portions 108, 110, respectively. It is within the scope of this disclosure and as a non-limiting example that the interactive machine 100 may be a gambling machine, a casino game, and the like. Additionally, it is within the scope of this disclosure and as a non-limiting example that the interactive machine 100 may be a video poker machine, a slot machine, a video slot machine, gambling kiosk, a redemption machine, a note breaker machine, a video gambling machine, and the like. Furthermore, it is within the scope of this disclosure and as a non-limiting example that the interactive machine 100 may be an arcade machine, an arcade game, a kiosk, a vending machine, an automated teller machine (ATM), and the like.

At least a portion of the front portion 104 of the housing 101 of the interactive machine 100 may include at least one user interface 114. As best seen in FIG. 1 of the disclosure and as a non-limiting example, at least a portion of the at least one user interface 114 may be disposed within at least a portion of the top portion 108 and/or the intermediate portion 112 of the front portion 104 of the housing 101. The at least one user interface 114 may be operably configured to display at least a portion of an output (not shown). The output may be any type of output as desired such as user information, a program, a game, a menu, and the like, for example. In order to display at least a portion of the output on the at least one user interface 114, the at least one user interface 114 may be in communication with a control unit 116. It is within the scope of this disclosure and as a non-limiting example that the at least one user interface 114 may be a vacuum tube display, a cathode-ray tube (CRT) type display, a plasma type display, a liquid-crystal display (LCD) type display, an organic light-emitting diode (OLED or Organic LED) type display, an active-matrix organic light-emitting diode (AMOLED) type display, a quantum dot (QD) display, and/or any other type of display that is capable of displaying at least a portion of the output. Additionally, it is within the scope of this disclosure that the at least one user interface 114 may be a non-touch screen type display and/or a touch screen type display capable of interacting with a user (not shown) and/or at least a portion of the output.

The interactive machine 100 may include the use of at least one audible device 115 (e.g. a speaker). The at least one audible device 115 of the interactive machine 100 may be operably configured to emit at least one sound (not shown) associated with the output. At least a portion of the at least one audible device 115 may be received and/or retained within at least a portion of the housing 101 of the interactive machine 100. It is within the scope of this disclosure and as a non-limiting example that the at least one audible device 115 may be disposed within at least a portion of the top portion 108, the bottom portion 110, and/or the intermediate portion 112 of the housing 101. Additionally, it is within the scope of this disclosure and as a non-limiting example that at least a portion of the housing 101 and/or the at least one user interface 114 may be operably configured to emit at least one sounds (not shown) associated with the output.

As illustrated in FIG. 2 and as a non-limiting example, at least a portion of the control unit 116 may be received and/or retained within at least a portion of a hollow interior portion 118 of the housing 101 of the interactive machine 100. The control unit 116 of the interactive machine 100 may be operably configured to store and/or control all aspects of the output or the control unit 116 may be operably configured to control pre-determined aspects of the output. In accordance with the embodiment where the control unit 116 does not store the entire output and is only operably configured to store at least a portion of and control pre-determined aspects of the output, the control unit 116 may be in communication with a main controller or cloud based control unit 120. The main controller or cloud based control unit 120 may be operably configured to store at least a portion of the output thereon and to instruct the control unit 116 to instruct the at least one user interface 114 and/or the at least one audible device 115 to display at least one images and/or emit at least one sounds associated with the output.

It is within the scope of this disclosure and as a non-limiting example that the control unit 116 of the interactive machine 100 may be in wired communication with the main controller or cloud based control unit 120 or may be in wireless communication with the main controller or cloud based control unit 120. According to the embodiment where the control unit 116 is in wireless communication with the main controller or cloud based control unit 120, the control unit 116 may be in communication with the main controller or cloud based control unit 120 by using a Wi-Fi connection, a Bluetooth connection, a satellite connection, an infrared connection, a cellular or mobile connection, a 5G connection, an optical connection, a broadcast radio connection, a microwave connection, and/or any other type of wireless connection that allows the transmission and receipt of an amount of data or information.

As best seen in FIG. 2 of the disclosure and as a non-limiting example, the interactive machine 100 may include the use of a telematics unit 146 to facilitate the communication between the control unit 116 and the main controller or cloud based control unit 120. At least a portion of the telematics unit 146 may be received and/or retained within at least a portion of the hollow interior portion 118 of the housing 101 of the interactive machine 100.

In order for the user to interact with the at least one user interface 114 of the interactive machine 100, the interactive machine 100 may include at least one user input device 122. The at least one user input device 122 may be operably configured to allow the user to interact with the at least one user interface 114 as needed by the output (e.g. play the game, select menu options, etc.). Additionally, the at least one user input device 122 may be operably configured to communicate with the control unit 116 and/or the main controller or cloud based control unit 120 as needed to allow the user to navigate the output. As a non-limiting example, the at least one user input device 122 may be at least one button, at least one joystick, at least one knob, at least one touch key, at least one switch, at least one lever, and any other suitable actuator as desired.

The control unit 116 of the interactive machine 100 may include the use of at least one input device sensor 123. The at least one input device sensor 123 may be operably configured to sense which one of the at least one user input device 122 has been activated by the user to operate the interactive machine 100 and/or to interact with the output. The control unit 116 and/or the main controller or cloud based control unit 120 may be operably configured to determine: an amount of time the at least one user input device 122 has been utilized by the user, an amount of time between utilization of the at least one user input device 122 by the user, an amount of time lapsed since the at least one user input device 122 has been utilized by the user, an amount of time between separate interactions of the user with the output (e.g. plays of a game) on the interactive machine 100, and/or an amount of time since an output (e.g. a game) has been initiated on the interactive machine 100. It is within the scope of this disclosure and as a non-limiting information that at least a portion of the data collected by the control unit 116 relating to the user's interactions with the at least one user input device 122 may be utilized by the control unit 116 and/or the main controller or cloud based control unit 120 to identify when the interactive machine 100 should: enter into a sleep mode, exit a sleep mode, enter into a low power mode, enter into a battery operated mode, and/or exit a battery operated mode.

The interactive machine 100 may include an identification portion 124 (e.g. a name portion) displaying at least a portion of the identity (e.g. name of the game) (not shown) of the interactive machine 100. The identification portion 124 aids in conveying to the user the type of output that the interactive machine 100 can produce and/or process. In accordance with the embodiment illustrated in FIG. 1 and as a non-limiting example, at least a portion of the identification portion 124 of the interactive machine 100 may be disposed within at least a portion of the front portion 104 of the housing 101 and/or the bottom portion 110 of the front portion 104 of the housing 101. It is within the scope of this disclosure and as a non-limiting example that the identification portion 124 of the interactive machine 100 may be an identification member (e.g. a name plate) (not shown), at least one user interface 114, a portion of the housing 101, and/or any other member for illustrating the identity of the interactive machine 100.

According to the embodiment illustrated in FIG. 1 of the disclosure and as a non-limiting example, the interactive machine 100 may include at least one visual indicator 126 (e.g. a light). The at least one visual indicator 126 may be used to illuminate at least a portion of the interactive machine 100, to identify or communicate at least one aspect of the output, to draw in the user to interact with the interactive machine 100, to maintain the user's attention, and/or to communicate to the user that at least one article 128 (e.g. tickets, coupons, vouchers, tokens, prizes, rewards, money including coins and bills, credits, etc.) are available for collection by the user. As a non-limiting example, the at least one visual indicator 126 may be at least one LED light, at least one fluorescent light, and/or at least one incandescent light.

According to an embodiment of the disclosure and as a non-limiting example, the interactive machine 100 may include at least one article dispensing device 129. The at least one article dispensing device 129 may be operably configured to dispense the at least one article 128 determined by the control unit 116 to be provided to the user during operation of the interactive machine 100. Additionally, it is within the scope of this disclosure and as a non-limiting example that the at least one article 128 may be progressive in nature allowing the article 128 to increase over time based on the number of user's interactions and/or the user's wager.

As best seen in FIG. 2 and as a non-limiting example, the interactive machine 100 may include the use of an article generator 131 (e.g. a printer) and/or an article dispenser 133. According to an embodiment of the disclosure and as a non-limiting example, at least a portion of the article generator 131 and/or the article dispenser 133 may be disposed within at least a portion of the hollow interior portion 118 of the top portion 108 of the housing 101 of the interactive machine 100. The article generator 131 may be operably configured to generate at least one article 128 and the article dispenser 133 may be operably configured to dispense at least one article 128 to the user while interacting with the interactive machine 100 (e.g. playing the game).

According to an embodiment of the disclosure and as a non-limiting example, the article generator 131 and/or the article dispenser 133 may include the use of a generator access door 135 and/or a dispenser access door 137 respectively. The generator access door 135 and/or the dispenser access door 137 may be utilized to access the internals of the article generator 131 and/or the article dispenser 133 as needed for maintenance purposes and/or to add more articles 128 therein.

It is within the scope of this disclosure that the article generator 131 and/or the article dispenser 133 may include the use of at least one article generator sensor 139 and/or at least one article dispenser sensor 141 respectively. The at least one article generator sensor 139 and/or the at least one article dispenser sensor 141 may be operably configured to identify when the article generator access door 135 and/or the article dispenser access door 137 has been opened or closed. As a non-limiting example, the data collected by the at least one article generator sensor 139 and/or the at least one article dispenser sensor 141 may be utilized by the control unit 116 and/or the main controller or cloud based control unit 120 in order to determine when the interactive machine 100 should: enter into a maintenance mode, a low power mode, enter into a battery operated mode, and/or exit a battery operated mode. As a result, it is therefore to be understood that the article generator 131 and/or the article dispenser 133 may be in wired or wireless communication with the control unit 116 of the interactive machine 100.

In accordance with the embodiment illustrated in FIG. 1 and as a non-limiting example, the at least one article 128 may be dispensed by the interactive machine 100 and provided to the user in at least one article receiving portion 130. The at least one article receiving portion 130 may be of a size and shape needed to receive and/or retain at least a portion of the at least one article 128 dispensed by the interactive machine 100. As a non-limiting example, at least a portion of the at least one article receiving portion 130 may be disposed within at least a portion of the bottom portion 110 of the front portion 104 of the housing 101 of the interactive machine 100.

The interactive machine 100 may include the use of a coin dispenser 136 having a coin dispenser access door 138, a coin receiving portion 140, and/or a coin dispensing portion 142. As best seen in FIG. 2 and as a non-limiting example, at least a portion of the coin dispenser 136 may be received and/or retained within at least a portion of the hollow interior portion 118 of the housing 101 of the interactive machine 100. The coin dispenser 136 may be operably configured to receive, house, and/or dispense an amount of the at least one article 128 (e.g. tokens, coins, money, etc.) earned by the user from the interactive machine 100 to the user. As a result, it is therefore to be understood that at least a portion of the coin dispensing portion 142 may be in communication with at least a portion of the at least one article receiving portions 130 of the interactive machine 100.

The coin dispenser 136 may include the use of at least one coin dispenser sensor 144 in communication with the control unit 116 of the interactive machine 100. As best seen in FIG. 2 of the disclosure and as a non-limiting example, at least a portion of the at least one coin dispenser sensor 144 may be disposed within at least a portion of the coin dispenser 136. Additionally, as best seen in FIG. 2 and as a non-limiting example, at least a portion of the control unit 116 may be received and/or retained within at least a portion of the hollow interior portion 118 of the housing 101 of the interactive machine 100. The at least one coin dispenser sensor 144 may be operably configured to sense the receipt of an amount of the at least one article 128 (e.g. tokens, coins, money, etc.) received and/or dispensed by the coin dispenser 136. The control unit and/or the main controller or cloud based control unit 120 may utilize the data collected by the at least one coin dispenser sensor 144 in order to: determine or count the amount of the at least one article 128 (e.g. tokens, coins, money, etc.) received by the coin dispenser 136; to determine or count the amount of the at least one article 128 (e.g. tokens, coins, money, etc.) dispensed by the coin dispenser 136; to determine the amount of the at least one article 128 (e.g. tokens, coins, money, etc.) that is disposed within the coin dispenser 136 at any given time; and/or to determine how long the user can interact with the interactive machine 100 given the amount of the at least one article 128 (e.g. tokens, coins, money, etc.) inserted and the average duration of a single user interaction with the interactive machine 100 (e.g. play a game).

According to an embodiment of the disclosure and as a non-limiting example, the control unit 116 and/or the main controller or cloud based control unit 120 may be operably configured to utilize the data collected by the at least one coin dispenser sensor 144 to determine when the interactive machine 100 should: exit a sleep mode entered into, exit a low power mode entered into, enter into a high power mode of operation, enter into a battery operated mode, and/or exit a battery operated mode.

The coin receiving portion 140 of the coin dispenser 136 may be of a size and shape to receive and/or collect an amount of the at least one article 128 (e.g. tokens, coins, money, etc.) received by the interactive machine 100. It is within the scope of this disclosure and as a non-limiting example that at least a portion of the at least one coin dispenser sensor 144 may be disposed within at least a portion of the coin receiving portion 140 of the coin dispenser 136 to sense the receipt of an amount of the at least one article 128 (e.g. tokens, coins, money, etc.) received by the interactive machine 100.

The coin dispenser access door 138 of the coin dispenser 136 may be utilized to access the internals of the coin dispenser 136 as needed for maintenance purposes and/or to add an amount of the at least one article 128 (e.g. tokens, coins, money, etc.) into the coin dispenser 136. It is within the scope of this disclosure that the at least one coin dispenser sensor 144 may be operably configured to identify when the coin dispenser access door 138 of the coin dispenser 136 has been opened or closed. The data collected by the at least one coin dispenser sensor 144 may be utilized by the control unit 116 and/or the main controller or cloud based control unit 120 in order to determine when the interactive machine 100 should: enter into a maintenance mode, entered into a retrieval mode, a low power mode, enter into a battery operated mode, and/or exit a battery operated mode. As a result, it is therefore to be understood that the coin dispenser 136 may be in wired or wireless communication with the control unit 116 of the interactive machine 100.

As best seen in FIG. 1 of the disclosure and as a non-limiting example, the interactive machine 100 may include the use of a user identification card 148 having a user identification portion 150. The user identification portion 150 of the user identification card 148 may be a card that is user specific and/or may be used to identify the specific user that is using the interactive machine 100 at any given time. The user identification portion 150 of the user identification card 148 may be inserted into a card reader 152 by the user before and/or during operation of the interactive machine 100. As best seen in FIG. 2 and as a non-limiting example, at least a portion of the card reader 152 may be received and/or retained within at least a portion of the hollow interior portion 118 of the housing 101 of the interactive machine 100. It is within the scope of this disclosure and as a non-limiting example that the user identification portion 150 of the user identification card 148 may be a magnetic strip, a barcode, and radio frequency identification (RFID) tag, a solid state memory, a microchip, and/or any other type of device that is capable of providing a unique identification for a particular user of the interactive machine 100. As a non-limiting example, the user identification portion 150 of the user identification card 148 may be printed onto, incorporated within the user identification card 148, and/or molded into a user gaming card.

In accordance with an embodiment of the disclosure and as a non-limiting example the card reader 152 of the interactive machine 100 may read the information contained on the user identification card 148 by scanning the user identification card 148, swiping the user identification card 148, by insertion of the user identification card 148 within the card reader 152, by a top to read type of communication, and/or by wireless communication of the user identification portion 150 of the user identification card 148 via a near field communication (NFC) reader.

According to an embodiment of the disclosure and as a non-limiting example, the card reader 152 may include a card reader access door 154 and/or at least one card reader sensor 156. The card reader access door 154 may be utilized to access the internals of the card reader 152 as needed for maintenance purposes. The at least one card reader sensor 156 may be operably configured to read the information on the user identification card 148, to determine when the card reader access door 154 has been opened, and/or to determine when the card reader access door 154 has been closed. It is within the scope of this disclosure and as a non-limiting example that the data collected by the at least one card reader sensor 156 may be utilized by the control unit 116 and/or the main controller or cloud based control unit 120 in order to determine when the interactive machine 100 should: enter into a maintenance mode, exit a sleep mode entered into, a low power mode, enter into a battery operated mode, and/or exit a battery operated mode. As a result, it is therefore to be understood that the card reader 152 may be in wired or wireless communication with the control unit 116 and/or the main controller or cloud based control unit 120.

The user identification card 148 may be loadable with an amount of the at least one article 128 (e.g. tickets, coupons, vouchers, tokens, prizes, rewards, money including coins and bills, credits, etc.) as needed by the user. The at least one article 128 (e.g. tickets, coupons, vouchers, tokens, prizes, rewards, money including coins and bills, credits, etc.) added to the user identification card 148 may be redeemable by the user and/or may be utilized by the user as needed to operate the interactive machine 100. Additionally, the interactive machine 100 and/or the main controller or cloud based control unit 120 may add an amount of tokens, credits, and/or money to the user identification card 148 as they are earned by the user during operation of the interactive machine 100. The control unit 116 and/or the main controller or cloud based control unit 120 may utilize this data in order to determine how long the user can interact with the interactive machine 100 given the amount of the at least one article 128 (e.g. tickets, coupons, vouchers, tokens, prizes, rewards, money including coins and bills, credits, etc.) added to the user's identification card 148 or a user profile (not shown) and the average duration of a single user interaction with the interactive machine 100 (e.g. play a game).

It is within the scope of this disclosure and as a non-limiting example that the information relating to the amount of the at least one article 128 (e.g. tickets, coupons, vouchers, tokens, prizes, rewards, money including coins and bills, credits, etc.) available to the user to operate the interactive machine 100 may be stored and retrievable from the user identification card 148, may be stored and retrievable from the control unit 116 of the interactive machine 100, and/or may be stored and retrievable from the main controller or cloud based control unit 120. In light of the foregoing, it is within the scope of this disclosure and as a non-limiting example that the user identification card 148, the control unit 116 of the interactive machine 100, and/or the main controller or cloud based control unit 120 may include the user profile that is specific to the individual user and accessible by the user by utilizing the user identification card 148.

The user profile may continuously collect data relating to the user's interactions with the interactive machine 100 (e.g. user habits). As a non-limiting example, the data collected by the control unit 116 and/or the main controller or cloud based control unit 120 may include: the types of games that the user prefers to play, the average time it takes the user to play a particular type of game, the average number of games that the user will play in a single sitting or play session, and/or the types of game(s) loaded onto the interactive machine 100. This data may be utilized by the control unit 116 and/or the main controller or cloud based control unit 120 in order: to predict the game(s) that the user will play on the interactive machine 100 based on the types of games that the user likes to play and the types game(s) loaded on the interactive machine 100; to predict how long the user will interact with the interactive machine 100 in a single sitting or play session based on the user's average time to play a particular game, the games loaded on the interactive machine 100, the average number of games the user will play in single sitting or play session, the types of games the user likes to play; how long the user can interact with the interactive machine 100 given the amount of at least one article 128 (e.g. tickets, coupons, vouchers, tokens, prizes, rewards, money including coins and bills, credits, etc.) inserted into the interactive machine 100, loaded onto the user's profile, and/or loaded onto the user's identification card 148, to determine when the interactive machine 100 should enter into a low power mode; to determine when the interactive machine 100 should exit a low power mode; to determine when the interactive machine 100 should enter into a high power mode; to determine when the interactive machine 100 should exit a high power mode; to determine when the interactive machine 100 should enter into a battery power mode; and/or to determine when the interactive machine 100 should exit a battery power mode.

As best seen in FIG. 1 and as a non-limiting example the interactive machine 100 may include at least one receiving device 158. The at least one receiving device 158 may be operably configured to receive and/or determine an amount of the at least one article 128 (e.g. tickets, coupons, vouchers, tokens, prizes, rewards, money including coins and bills, credits, etc.)inserted into the interactive machine 100 by the user. Once a pre-determined amount of the at least one article 128 (e.g. tickets, coupons, vouchers, tokens, prizes, rewards, money including coins and bills, credits, etc.) have been received by the interactive machine 100, the user may interact with the interactive machine 100 and/or may play at least one game.

The at least one receiving device 158 may include at least one receiving device sensor (not shown). The at least one receiving device sensor (not shown) may be operably configured to sense the insertion of an amount of the at least one article 128 (e.g. tickets, coupons, vouchers, tokens, prizes, rewards, money including coins and bills, credits, etc.) inserted into the interactive machine 100 and/or to determine an amount of the at least one article 128 (e.g. tickets, coupons, vouchers, tokens, prizes, rewards, money including coins and bills, credits, etc.) inserted into the interactive machine 100. Additionally, the control unit 116 may be operably configured to determine the amount of the at least one article 128 (e.g. tickets, coupons, vouchers, tokens, prizes, rewards, money including coins and bills, credits, etc.) inserted into the interactive machine 100 and/or what time the user put an amount of the at least one article 128 (e.g. tickets, coupons, vouchers, tokens, prizes, rewards, money including coins and bills, credits, etc.) into the interactive machine 100. As a non-limiting example, the data collected from the at least one receiving device sensor may be utilized by the control unit 116 and/or the main controller or cloud based control unit 120 in order to determine when the interactive machine 100 should: exit a sleep mode entered into, enter into a low power mode, enter into a high power mode, enter into a battery operated mode, exit a battery operated mode, and/or exit or transition out of a low power mode. Additionally, it is within the scope of this disclosure and as a non-limiting example that the data collected by the at least one receiving device sensor may be utilized by the control unit 116 and/or the main controller or cloud based control unit 120 in order to determine how long the user can interact with the interactive machine 100 given the amount of the at least one article 128 (e.g. tickets, coupons, vouchers, tokens, prizes, rewards, money including coins and bills, credits, etc.) inserted and the average duration of a single user interaction with the interactive machine 100 (e.g. play a game).

In accordance with the embodiment where the at least one receiving device 158 receives an amount of the at least one article 128 (e.g. coins.), at least a portion of the at least one receiving device 158 may be in communication with at least a portion of the coin receiving portion 140 of the coin dispenser 136. As a result, it is therefore to be understood that the at least one article 128 (e.g. money in the form of coins) inserted into the interactive machine 100 via the at least one receiving device 158 may be received by the coin dispenser 136.

According to the embodiment where the at least one receiving device 158 receive an amount of the at least one article 128 (e.g. money in the form of bills), the at least one article 128 may be received within a note stacker 160. The note stacker 160 may be operably configured to receive, retain, and/or stack an amount of the at least one article 128 therein. As best seen in FIG. 2 and as a non-limiting example, at least a portion of the note stacker 160 may be received and/or retained within at least a portion of the hollow interior portion 118 of the housing 101 of the interactive machine 100.

The note stacker 160 and/or the at least one receiving device 158 may include at least one note sensor 162. The at least one note sensor 162 may be operably configured to sense or detect the insertion of an amount of the at least one article 128 into the interactive machine 100 and/or to count the total number of the at least one article 128 inserted into the interactive machine 100 by the user. The data collected by the at least one note sensor 162 may be utilized by the control unit 116 and/or the main controller or cloud based control unit 120 in order to determine the amount of the at least one article 128 inserted into the interactive machine 100, the time at which the at least one article 128 was inserted into the interactive machine 100, how long the user can interact with the interactive machine 100 given the amount of the at least one article 128 inserted and the average duration of a single user interaction with the interactive machine 100 (e.g. play a game), when the interactive machine 100 should enter into a low power mode, when the interactive machine 100 should exit a low power mode, when the interactive machine 100 should enter into a battery operated mode, when the interactive machine 100 should exit a battery operated mode, when the machine should exit a sleep mode entered into, when the interactive machine 100 should enter into a high power mode, and/or when the interactive machine 100 should exit a high power mode.

As best seen in FIG. 2 and as a non-limiting example, the note stacker 160 may include a note stacker access door 164. The note stacker access door 164 may be utilized as needed to access the internals of the note stacker 160 as needed for maintenance purposes and/or to retrieve an amount of the at least one article 128 stored therein as needed. It is within the scope of this disclosure that the at least one note sensor 162 may be operably configured to identify when the note stacker access door 164 has been opened. This data may be utilized by the control unit 146 and/or the main controller or cloud based control unit 120 in order to determine if the interactive machine 100 has entered into a maintenance mode and/or a retrieval mode.

According to the embodiment illustrated in FIG. 2 and as a non-limiting example, the interactive machine 100 may include a drop box 166. At least a portion of the drop box 166 may be received and/or retained within at least a portion of the hollow interior portion 118 of the housing 101 of the interactive machine 100. The drop box 166 may be of a size and shape to receive and/or retain a pre-determine portion of the at least one article 128 (e.g. tickets, coupons, vouchers, tokens, prizes, rewards, money including coins and bills, credits, etc.) (e.g. house's “take”) from the interactive machine 100.

The drop box 166 may include at least one drop box sensor 168. The at least one drop box sensors 168 may be operably configured in order to determine when the drop box 166 is being accessed. This data may be utilized by the control unit 116 and/or the main controller or cloud based control unit 120 in order to determine when the interactive machine 100: has entered into a maintenance mode, has entered into a retrieval mode, a low power mode, enter into a battery operated mode, and/or exit a battery operated mode. As a result, it is therefore to be understood that the drop box 166 may be in wired or wireless communication with the control unit 116 of the interactive machine 100.

In order to access at least one of the components of the interactive machine 100 identified herein, the housing 101 of the interactive machine 100 may include at least one machine access door 170. The at least one machine access door 170 may include at least one machine access door sensor 172. The at least one machine access door sensor 172 may be operably configured in order to determine when the at least one machine access door 170 has been opened and/or closed. This data may be utilized by the control unit 116 and/or the main controller or cloud based control unit 120 in order to determine when the interactive machine 100: has entered into a maintenance mode, a retrieval mode, a low power mode, and/or a battery operated mode, and/or exited a battery operated mode. As a result, it is therefore to be understood that the at least one machine access door sensor 172 may be in wired or wireless communication with the control unit 116 of the interactive machine 100.

As illustrated in FIG. 1 of the disclosure and as a non-limiting example, the interactive machine 100 may include at least one service alert 174. The at least one service alert 174 may be utilized by the user to request a server and/or to order an amount of food and/or drinks from an establishment (e.g. owner, manager, etc. of the interactive machine 100). This data may be collected and utilized by the control unit 116 and/or the main controller or cloud based control unit 120 to determine if the interactive machine 100 to enter into a low power mode, exit a low power more, enter into a battery operated mode, exit a battery operated mode, enter into a high power mode, and/or to exit a high power mode. This determination may be based on how busy the establishment is, the time of day that the at least one service alert 174 is utilized by the user, the average amount of time for a server to travel to the user, and/or the average amount of time to prepare the food and/or drinks requested.

It is within the scope of this disclosure and as a non-limiting example that the at least one service alert 174 may be incorporated within a device 175 that is in wired and/or wireless communication with the control unit 116, the telematics unit 146, and/or a power source control unit 184 of a power system 176. As a non-limiting example, the device 175 may be connected to at least a portion of the housing 101 of the interactive machine 100. Additionally it is within the scope of this disclosure and as a non-limiting example that the device 175 may be a kiosk type machine.

The interactive machine 100 may include the use of a power system 176. As best seen in FIG. 2 and as a non-limiting example, the power system 176 may include at least one first power source 178 and/or at least one power source sensor 180. As a non-limiting example, the power system 176 may include a plurality of first power sources 178. The power system 176 may be in wireless or wired communication with the control unit 116 and/or the main controller or cloud based control unit 120 in order to control the operation of the power system 176 of the interactive machine 100. It is within the scope of this disclosure and as a non-limiting example that the at least one first power source 178 may be at least one electro-chemical cell, at least one battery, at least one rechargeable battery, at least one Li-ion battery, at least one secondary cell, and/or any other type of device that is chargeable or rechargeable with an amount of energy that may be consumed by the interactive machine 100 as needed.

As best seen in FIG. 2 and as a non-limiting example, the power system 176 may by a hybrid power system and also be in electrical communication with at least one second power source 182. In certain embodiments, the at least one second power source 182 may be any type of power source capable of supplying the first power source 178 with an amount of power needed to operate the interactive machine 100. As a non-limiting example, the at least one second power source 182 may be a solar power source. As another non-limiting example, the at least one second power source 182 may be an electrical grid (e.g. municipal electrical system). It is within the scope of this disclosure and as a non-limiting example that the second source of power 182 may supplying either 110 volts, 120 volts, or 220 volts. As a result, it is therefore to be understood that the control unit 116 and/or the main controller or cloud based control unit 120 may be operably configured to instruct the power system 176 to power the interactive machine 100 using at least one of the first power source 178 and the at least one second power source 182.

It is within the scope of this disclosure and as a non-limiting example that the low power mode discussed previously herein may be when the amount of power used by the interactive machine 100 is equal to or less than the overall amount of power that may be provided by the at least one first power source 178. Additionally, it is within the scope of this disclosure and as a non-limiting example that the high power mode discussed previously herein may be when the amount of power that is determined to be used by the interactive machine 100 is greater than the amount of power that the at least one first power source 178 can provide the interactive machine 100.

The at least one power source sensor 180 may be operably configured to identify, detect, and/or monitor the amount of power within the at least one first power source 178 at any given time. The at least one power source sensor 180 may be in wireless or wired communication with the control unit 116 and/or the main controller or cloud based control unit 120. The data collected from the at least one power source sensor 180 may be utilized by the control unit 116 and/or the main controller or cloud based control unit 120 in order to determine if the power system 176 should supply the interactive machine 100 with an amount of power from the at least one first power source 178 and/or the at least one second power source 182 and/or to determine if the power system 176 should switch from providing the interactive machine 100 with power from the at least one first power source 178 to providing the machine with power from the at least one second power source 182.

Additionally, the control unit 116 and/or the main controller or cloud based control unit 120 may be operably configured to instruct the power system 176 to supply the at least one first power source 178 with an amount of power needed to recharge the at least one first power source 178 for additional uses by the interactive machine 100.

Additionally, as best seen in FIG. 2 of the disclosure and as a non-limiting example, the power system 176 may include the use of at least one heat transfer element 186. The at least one heat transfer element 186 may be operably configured in order to transfer an amount of heat from the at least one first power source 178, the power system 176, and/or the interactive machine 100. The at least one heat transfer element 186 aid in keeping the interactive machine 100, the power system 176, and/or the at least one first power source 178 from overheating, thereby aiding in increasing the overall life and durability of the interactive machine 100, the power system 176, and/or the at least one first power source 178. It is within the scope of this disclosure and as a non-limiting example at least one heat transfer element 186 may be at least one heat sink and/or at least one fan.

The control unit 116, the power source control unit 184, and/or the main controller or cloud based control unit 120 may be operably configured to determine a failure by utilizing the data collected by the at least one power source sensor 180. It is within the scope of this disclosure and as a non-limiting example that the failure may be a failure of the at least one first power source 178, the at least one second power source 182, at least one heat transfer elements 186, power source control unit 184, an/or any other type of malfunction within the power system 176 of the interactive machine 100.

In the event that the failure detected is in the at least one first power source 178 of the power system 176, the control unit 116, the power source control unit 184, and/or the main controller or cloud based control unit 120 may instruct the power system 176 to supply the interactive machine 100 to enter into a maintenance mode and/or a high power mode and supply power to the interactive machine 100 via the at least one second power source 182 only. Once in the maintenance mode, the interactive machine 100 may be powered by the at least one first power source 178 only.

In the event that the failure detected is in the at least one second power source 182, the control unit 116, the power source control unit 184, and/or the main controller or cloud based control unit 120 may instruct the power system 176 to supply the interactive machine 100 to enter into a maintenance mode, a low power mode, and/or a battery operated mode and supply power to the interactive machine 100 via the at least one first power source 178 only.

In the event that the failure detected is in the at least one heat transfer element 186, the control unit 116, the power source control unit 184, and/or the main controller or cloud based control unit 120 may instruct the power system 176 to enter into a maintenance mode and/or a high power mode and supply power to the interactive machine 100 via the at least one second power source 182.

In the event that the failure detected is in the power source control unit 184, the control unit 116, the power source control unit 184, and/or the main controller or cloud based control unit 120 may enter the machine into a maintenance mode and stop supplying the interactive machine 100 with power.

According to an embodiment of the disclosure and as a non-limiting example, the interactive machine 100 may include at least one proximity sensor 188. The at least one proximity sensor 188 may be operably configured in order to determine if the user is within a pre-determined distance from the interactive machine 100 which may be indicative of an interest in the games (not shown) thereon or an interest by the user to interact or play the game(s) (not shown) on the interactive machine 100. The distance “X1” from the interactive machine 100 indicative of an interest to interact or play the game(s) on the interactive machine 100 may be less than the distance “X2” indicative of patrons of the establishment merely walking by the interactive machine 100 without interacting with the interactive machine 100.

The control unit 116, a power source control unit 184, and/or the main controller or cloud based control unit 120 may be in wireless or wired communication with the at least one proximity sensor 188 of the interactive machine 100. The control unit 116, a power source control unit 184, and/or the main controller or cloud based control unit 120 may be operably configured in order to record the foot traffic near the interactive machine 100 and/or to determine the overall interest or usage of the interactive machine 100 based on the percentage of users (not shown) that play the game versus the number of potential users (not shown) that walk by the interactive machine 100 without interacting with the interactive machine 100. Additionally, the control unit 116, a power source control unit 184, and/or the main controller or cloud based control unit 120 may be operably configured to determine an amount of time the user stands in front of the interactive machine 100 the distance “X2” which tends to show an interest by the user in at least one of the games on the interactive machine 100. Furthermore, the control unit 116, a power source control unit 184, and/or the main controller or cloud based control unit 120 may be utilized in order to determine how long it has been since someone has shown an interest in or played the game. It is within the scope of this disclosure and as a non-limiting example that the control unit 116, a power source control unit 184, and/or the main controller or cloud based control unit 120 may utilize the data collected by the at least one proximity sensor 188 to map out high traffic areas within the establishment, to have the interactive machine 100 enter into a sleep mode, to have the interactive machine 100 exit a sleep mode entered into, to enter into a low power mode, to exit a low power mode, to enter into a battery operated mode, to exit a batter operated mode, to enter into a high power mode, and/or to exit a high power mode.

According to an embodiment of the disclosure and as a non-limiting example, the power system 176 may be integrated into the interactive machine 100 as an integral component thereof when manufactures, may be replicable as needed, and/or may be incorporated into the interactive machine 100 as an aftermarket type of device.

In light of the foregoing, the interactive machine 100 and the power system 176 described and illustrated herein reduces the overall drain or strain the establishment puts on the power grid and therefore reduces the overall amount of power consumption by the establishment. Additionally, in light of the foregoing, it is therefore to be understood that the power system 176 described and illustrated herein aids in reducing the overall costs associated with the operation of the interactive machine 100. Furthermore, the in light of the foregoing, it is therefore to be understood that the interactive machine 100 and the power system 176 may be adaptive to the particular user using the interactive machine 100 thereby reducing the overall costs and power consumption associated with the interactive machine 100.

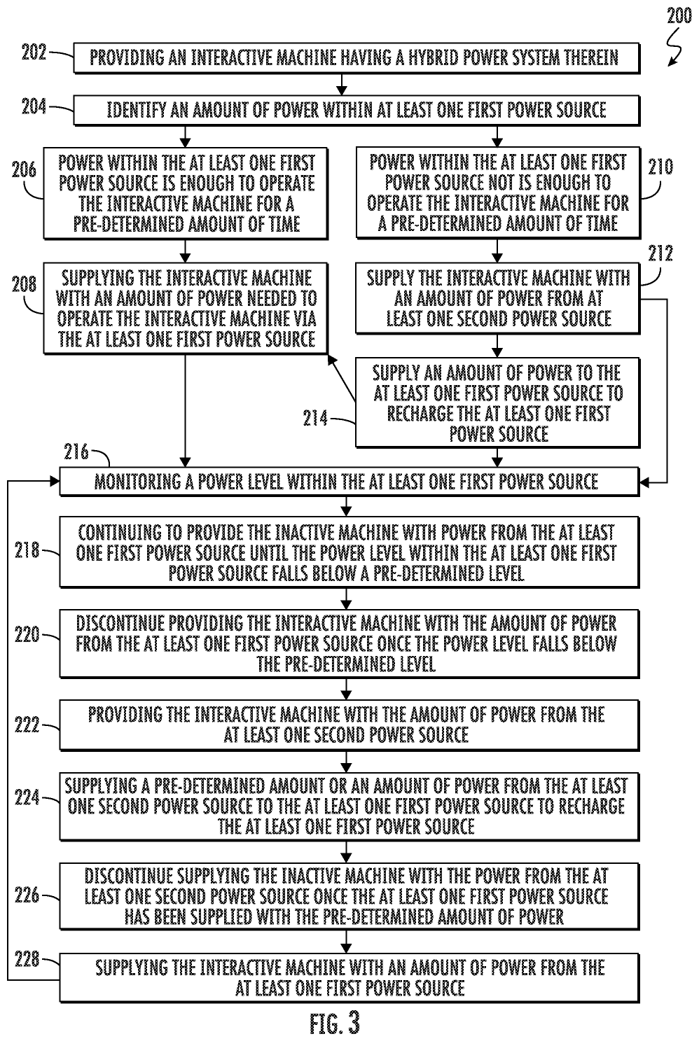

FIG. 3 provides a flow-chart illustrating a method of operation 200 for the interactive machine 100 and the hybrid power system 176 illustrated in FIGS. 1 and 2 according to an embodiment of the disclosure. The method of operation 200 includes step 202 of providing an interactive machine 100 having a hybrid power system 176 according to an embodiment of the disclosure. It is within the scope of this disclosure and as a non-limiting example that the hybrid power system 176 may be integrally formed as part of the interactive machine 100 as originally manufactured or installed within the interactive machine 100 as an aftermarket type device.

Utilizing the at least one power source sensors180 of the hybrid power system 176, the control unit 116, a power source control unit 184, and/or the main controller or cloud based control unit 120 may, in step 204, identify an amount of power within at least one first power source 178 of the power system 176. The power source control unit 184 may be operably configured in order to determine when the at least one first power source 178 and/or the at least one second power source 182 should be utilized to provide an amount of power needed to operate the interactive machine 100. It is within the scope of this disclosure and as a non-limiting example that the power source control unit 184 may be in wired or wireless communication with the control unit 116 and/or the main controller or cloud based control unit 120.

In step 206, the power within the at least one first power source 178 identified in step 204 is sufficient to operate the interactive machine 100 for a pre-determined amount of time. Then, in step 208, the control unit 116, the power source control unit 184, and/or the main controller or cloud based control unit 120 may instruct the at least one first power source 178 to supply the interactive machine 100 with the power needed to operate it. Alternatively, in step 210, in the event that the power within the at least one first power source 178 identified in step 204 is insufficient to operate the interactive machine 100 for a pre-determined amount of time, then, in step 212, the control unit 116, the power source control unit 184, and/or the main controller or cloud based control unit 120 may instruct at least one second power source 182 to supply the interactive machine 100 with an amount of power needed to operate it. While the at least one second power source 182 supplies the interactive machine 100 with the amount of power needed to operate the interactive machine 100, an amount of power may be supplied to the at least one first power source 178 to recharge the at least one first power source 178 in step 214. Once the at least one first power source 178 has been provided with a pre-determined amount of power (i.e. enough to fully charge the at least one first power source 178), the control unit 116, the power source control unit 184, and/or the main controller or cloud based control unit 120 may instruct the power system 176 to stop supplying an amount of power to the at least one first power source 178.

Once the power within the at least one first power source 178 has reached a pre-determined amount or level, the control unit 116, the power source control unit 184, and/or the main controller or cloud based control unit 120 may instruct the power system 176 to stop using the at least one second power source 182 and to supply the interactive machine 100 with an amount of power and may instruct the at least one first power source 178 of the power system 176, in step 212, to supply 212 the power needed to operate the interactive machine 100.

Thereafter, in step 216, a power level, or the amount of power within the at least one first power source 178, may be monitored 216 either continuously or at pre-determined intervals. The power level, or the amount of power within the at least one first power source 178, may be sensed by the at least one power source sensor 180 and that data may be utilized by the control unit 116, the power source control unit 184, and/or the main controller or cloud based control unit 120 in order to monitor the power, or the power level, within the at least one first power source 178.

In step 218, the at least one first power source 178 may continue to provide 218 the interactive machine 100 with the amount of power needed to operate the interactive machine 100 until the power level, or the amount of power within the at least one first power source 178, falls below a pre-determined amount. Once the power level, or the amount of power within the at least one first power source 178, falls below a pre-determine amount, the control unit 116, the power source control unit 184, and/or the main controller or cloud based control unit 120 may instruct the power system 176 in step 220 to discontinue providing power via the at least one first power source 178. The control unit 116, the power source control unit 184, and/or the main controller or cloud based control unit 120 may then instruct the power system 176 in step 222 to have the at least one second power source 182 to supply the interactive machine 100 with an amount of power needed to operate. In step 224, the control unit 116, the power source control unit 184, and/or the main controller or cloud based control unit 120 may then instruct the power system 176 to have the at least one second power source 182 to supply, a pre-determined amount of power, or an amount of power to the at least one first power source 178 to recharge the at least one power source 178.

Once the at least one first power source 178 have been supplied with the pre-determined amount of power or the amount of power to the at least one first power source 178 to recharge the at least one power source 178, the control unit 116, the power source control unit 184, and/or the main controller or cloud based control unit 120 may, in step 226, instruct the power system 176 to discontinue providing the power via the at least one second power source 182. The control unit 116, the power source control unit 184, and/or the main controller or cloud based control unit 120 may then, in step 228, instruct the at least one first power source 178 to supply an amount of power needed to operate the interactive machine 100. The steps 216 through 228 may be repeated until the interactive machine 100 is turned off or is no longer in use.

It is to be understood that while the power system 176 is switching between using the at least one first power source 178 and using the at least one second power source 182 as the primary power source for the interactive machine 100, there may be a period where both the first and second power sources 178 and 182 are both supplying power to the interactive machine 100. This aids in ensuring that the interactive machine 100 always has an amount of power needed to operate the interactive machine 100 in an uninterrupted manner.

In light of the foregoing, the interactive machine 100, the power system 176, and the method of operation 200 of the power system 176 described and illustrated herein reduces the overall drain or strain the establishment puts on the power grid and therefore reduces the overall amount of power consumption by the establishment. Additionally, in light of the foregoing, it is therefore to be understood that the power system 176 and the method of operation 200 of the power system 176 described and illustrated herein aids in reducing the overall costs associated with the operation of the interactive machine 100. Furthermore, the in light of the foregoing, it is therefore to be understood that the interactive machine 100, the power system 176, and/or and the method of operation 200 of the power system 176 may be adaptive thereby reducing the overall costs and power consumption associated with the interactive machine 100.

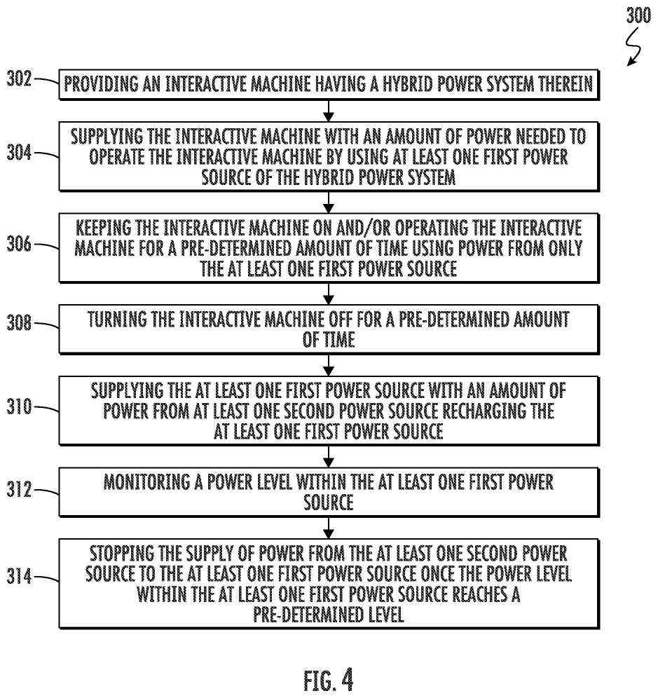

FIG. 4 provides a flow-chart illustrating a method of operation 300 for the interactive machine 100 and the hybrid power system 176 illustrated in FIGS. 1 and 2 according to an alternative embodiment of the disclosure. The method of operation 300 illustrated in FIG. 4 is the same as the method of operation 200 illustrated in FIG. 3, except where specifically noted below. The method of operation 300 includes a step 302 of providing an interactive machine 100 having a hybrid power system 176 according to an embodiment of the disclosure. It is within the scope of this disclosure and as a non-limiting example that the hybrid power system 176 may be integrally formed as part of the interactive machine 100 as originally manufactured or installed within the interactive machine 100 as an aftermarket type device.

Once the interactive machine 100 has been turned on, the at least one first power source 178 in step 304 supplies the interactive machine 100 with the amount of power needed to operate the interactive machine 100. In accordance with this embodiment of the disclosure, the at least one first power source 178 only provides the power needed to operate the interactive machine 100.

In step 306, the interactive machine 100 remains on and powered 306 by the at least one first power source 178 for a pre-determined amount of time. The pre-determined amount of time that the interactive machine 100 is on and powered by the at least one first power source 178 may be: the operating hours of the establishment having the interactive machine 100 therein, the operating hours for the interactive machine 100, the peak use hours identified for the interactive machine 100, the hours identified where the interactive machine 100 experiences no use, and/or the hours identified where the interactive machine 100 experiences minimal amounts of use.

The interactive machine 100 in step 308 may then be turned off for a pre-determined amount of time. While the interactive machine 100 is turned off, the at least one second power source 182 in step 310 may supply the at least one first power source 178 with an amount of power needed to recharge the at least one first power source 178. It is within the scope of this disclosure and as a non-limiting example that the off time identified may relate to the hours the establishment is closed for business, the time(s) when the interactive machine 100 experiences no use, and/or the time(s) when the interactive machine 100 is not in operation.

While the at least one second power source 182 is supplying the at least one first power source 178 with an amount of power to recharge, the control unit 116, the power source control unit 184, and/or the main controller or cloud based control unit 120 in step 312 may monitor, a power level or an amount of power within the at least one first power source 178. The power level or the amount of power within the at least one first power source 178 may be sensed by using the at least one power source sensor 180 as discussed previously herein. This aids in ensuring that the at least one first power source 178 are not over charged and/or over stressed thereby aiding in increasing the overall life and durability of the at least one first power source 178 of the power system 176.

Once the power within, or the power level within, the at least one first power source 178 reaches a pre-determined level, the control unit 116, the power source control unit 184, and/or the main controller or cloud based control unit 120 in step 314 may instruct the power system 176 to stop having the at least one second power source 182 supply the at least one first power source 178 with power. The steps 304 through 314 may be repeated until the interactive machine 100 is no longer in use.

It is to be understood that while the power system 176 is switching between using the at least one first power source 178 and using the at least one second power source 182 as the primary power source for the interactive machine 100, there may be a period where both the first and second power sources 178, 182 are both supplying power to the interactive machine 100. This aids in ensuring that the interactive machine 100 always has an amount of power needed to operate the interactive machine 100 in an uninterrupted manner.

In light of the foregoing, the interactive machine 100, the power system 176, and the method of operation 300 of the power system 176 described and illustrated herein reduces the overall drain or strain the establishment puts on the power grid and therefore reduces the overall amount of power consumption by the establishment. Additionally, in light of the foregoing, it is therefore to be understood that the power system 176 and the method of operation 300 of the power system 176 described and illustrated herein aids in reducing the overall costs associated with the operation of the interactive machine 100. Furthermore, the in light of the foregoing, it is therefore to be understood that the interactive machine 100, the power system 176, and/or and the method of operation 300 of the power system 176 may be adaptive thereby reducing the overall costs and power consumption associated with the interactive machine 100.

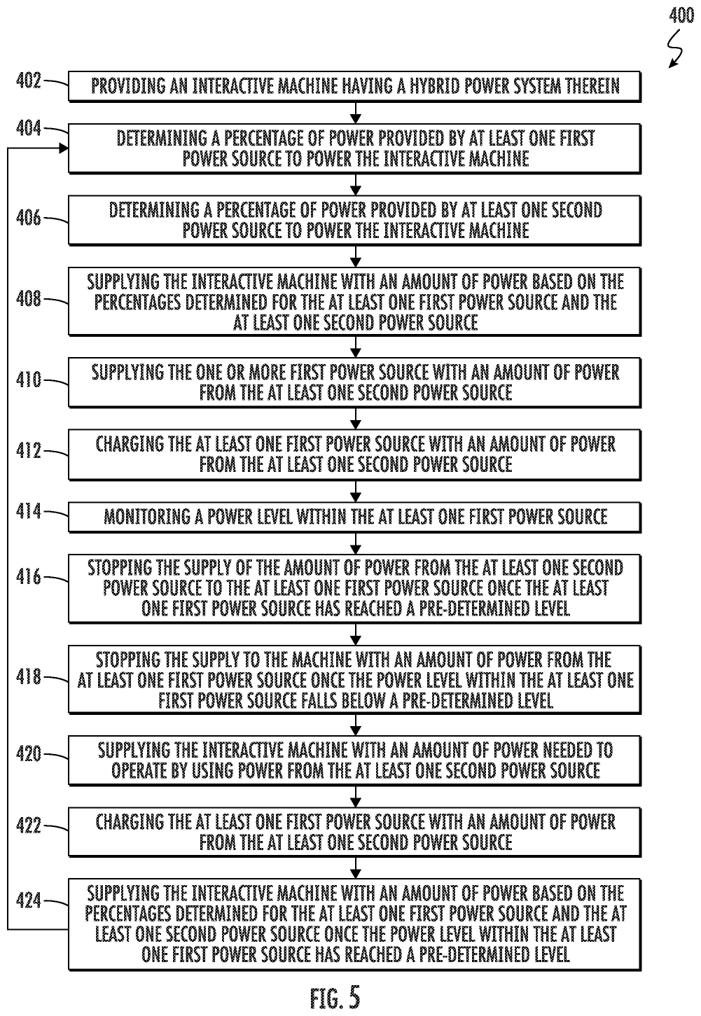

FIG. 5 provides a flow-chart illustrating a method of operation 400 for the interactive machine 100 and the hybrid power system 176 illustrated in FIGS. 1 and 2 according to another embodiment of the disclosure. The method of operation 400 illustrated in FIG. 5 is the same as the method of operation 200 and 300 illustrated in FIGS. 3 and 4, except where specifically noted below. The method of operation 400 includes the step 402 of providing an interactive machine 100 having a hybrid power system 176 according to an embodiment of the disclosure. It is within the scope of this disclosure and as a non-limiting example that the hybrid power system 176 may be integrally formed as part of the interactive machine 100 as originally manufactured or installed within the interactive machine 100 as an aftermarket type device.

Once provided, the control unit 116, the power source control unit 184, and/or the main controller or cloud based control unit 120, in step 404, may determine a percentage of power provided by the at least one first power source 178 to power the interactive machine 100. Additionally, once the interactive machine 100 has been provided, the control unit 116, the power source control unit 184, and/or the main controller or cloud based control unit 120, in step 406, may determine a percentage of power provided by the at least one second power source 178 to power the interactive machine 100. The percentages of power determined in step 404 and step 406 may be a fraction of the power needed to operate the machine. For example, if the power needed to operate the machine equals 100%, then the sum of the percentages of power determined in step 404 and step 406 for the first and second power sources 178, 182, respectively, will equal 100%.

The percentages of power determined in step 404 and step 406 may be based on a number of factors. It is within the scope of this disclosure and as a non-limiting example that the percentages of power determined in step 404 and step 406 may be based on if the interactive machine 100 is in a maintenance mode; if the interactive machine 100 is in a low power mode; if the interactive machine 100 is in a high power mode; if the interactive machine 100 is in a sleep mode; if the interactive machine 100 is in a high usage time; if the user has entered an amount of at least one article 128 (e.g. token, coin, credit, money, etc.) into the interactive machine 100 that is indicative of a long playing session; if the player's profile indicates that the user has a habit of playing a single machine for a long amount of time; if the at least one service alert 174 have been activated by the user; and/or what food and/or drink(s) were ordered by the user by interacting with the at least one service alert 174 of the interactive machine 100.

If the power demand for the interactive machine 100 in a particular time frame is high given increased usage within a pre-determined time frame, the percentage of power determined in step 406 provided by the at least one second power source 182 may be more than the percentage of power determined in step 404 provided by the at least one first power source 178 of the power system 176. In contrast, if the power demand for the interactive machine 100 in a particular time frame is low given little or no usage of the interactive machine 100 within a pre-determined time frame, the percentage of power determined in step 406 provided by the at least one second power source 182 may be less than the percentage of power determined in step 404 provided by the at least one first power source 178 of the power system 176.

After the percentages of power have been determined in step 404 and step 406, the at least one first power source 178 and the at least one second power source 182, in step 408, may supply the interactive machine 100 with the power needed to operate the interactive machine 100. While the at least one first power source 178 and the at least one second power source 182 supply the interactive machine 100 with an amount of power, an amount of power may also be supplied to the at least one first power source 178 by the at least one second power source 182 in step 410. This aids in step 412 of charging or replenishing the amount of power within the at least one first power source 178 in an effort to increase the overall amount of time that the at least one first power source 178 can supply 408 the interactive machine 100 with an amount of power needed to operate the interactive machine 100.

The control unit 116, the power source control unit 184, and/or the main controller or cloud based control unit 120, by using the data collected by the at least one power source sensor 180, in step 414, may monitor a power level, or an amount of power within, the at least one first power source 178 of the power system 176. It is within the scope of this disclosure and as a non-limiting example that the control unit 116, the power source control unit 184, and/or the main controller or cloud based control unit 120 may continuously monitor the power level of the at least one first power source 178 and/or may monitor the power level at pre-determined intervals.

Once the at least one second power source 182 has supplied the at least one first power source with a pre-determined amount of power, the control unit 116, the power source control unit 184, and/or the main controller or cloud based control unit 120, in step 416, may instruct the hybrid power system 176 to stop having the at least one second power source 182 supply the at least one first power source 178 with power. This aids in preventing the at least one first power source 178 from being over stressed or supplied with too much power which aids in increasing the overall life and durability of the at least one first power source 178 and the power system 176.

Once the amount of power within the at least one first power source 178 has fallen below a pre-determined amount, the control unit 116, the power source control unit 184, and/or the main controller or cloud based control unit 120, in step 418, may instruct the hybrid power system 176 to have the at least one first power source 178 stop supplying the interactive machine 100 with power. At this point, in step 420, the at least one second power source 182 may supply the interactive machine 100 with all of the power needed to operate the interactive machine 100.

While the at least one second power source 182 is supplying 420 the interactive machine 100 with the power needed to operate the interactive machine 100, the control unit 116, the power source control unit 184, and/or the main controller or cloud based control unit 120, in step 422, may instruct the power system 176 to have the at least one second power source 182 supply the at least one first power source 178 with an amount of power to charge the least one first power source 178. Once the at least one first power source 178 has obtained a pre-determined amount of power, the control unit 116, the power source control unit 184, and/or the main controller or cloud based control unit 120, in step 424, may instruct the first and second power sources 178, 182, respectively, to supply with an amount of power based on the percentages determined for that particular time of day. The steps 404 through 424 may be repeated until the interactive machine 100 is no longer in use.

It is to be understood that while the power system 176 is switching between using the at least one first power source 178 and using the at least one second power source 182 as the primary power source for the interactive machine 100, there may be a period where both the first and second power sources 178, 182, respectively, are both supplying power to the interactive machine 100. This aids in ensuring that the interactive machine 100 always has an amount of power needed to operate the interactive machine 100 in an uninterrupted manner.

In light of the foregoing, the interactive machine 100, the power system 176, and the method of operation 400 the power system 176 described and illustrated herein reduces the overall drain or strain the establishment puts on the power grid and therefore reduces the overall amount of power consumption by the establishment. Additionally, in light of the foregoing, it is therefore to be understood that the power system 176 and the method of operation 400 the power system 176 described and illustrated herein aids in reducing the overall costs associated with the operation of the interactive machine 100. Furthermore, the in light of the foregoing, it is therefore to be understood that the interactive machine 100, the power system 176, and/or and the method of operation 400 the power system 176 may be adaptive thereby reducing the overall costs and power consumption associated with the interactive machine 100.

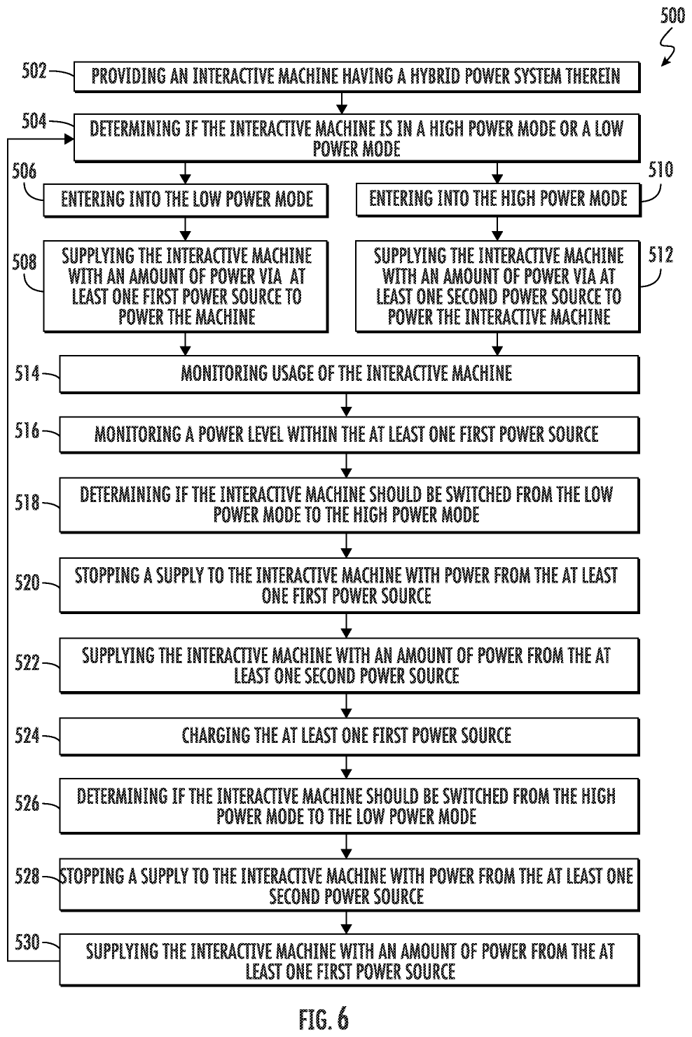

FIG. 6 provides a flow-chart illustrating a mode of operation 500 for the interactive machine 100 and the hybrid power system 176 illustrated in FIGS. 1 and 2 according to yet another embodiment of the disclosure. The mode of operation 500 illustrated in FIG. 6 is the same as the mode of operation 200, 300, and 400 illustrated in FIGS. 3-5, except where specifically noted below. The mode of operation 500 includes a step 502 of providing an interactive machine 100 having a hybrid power system 176 according to an embodiment of the disclosure. It is within the scope of this disclosure and as a non-limiting example that the hybrid power system 176 may be integrally formed as part of the interactive machine 100 as originally manufactured or installed within the interactive machine 100 as an aftermarket type device.

Once the interactive machine 100 and the hybrid power system 178 has been provided, the control unit 116, the power source control unit 184, and/or the main controller or cloud based control unit 120, in step 504 may determine if the interactive machine 100 should operate in a low power mode or a high power mode. This determination may be made by a number of factors and/or data collected by the various sensors of the interactive machine 100 described herein. It is within the scope of this disclosure and as a non-limiting example that the factors and/or data utilized to distinguish between the high power mode and the low power mode includes: if the interactive machine 100 is in a sleep mode; the amount of articles 128 (e.g. coins, tokens, credits, and/or money) put into the interactive machine 100, applied to the user's identification card 148, and/or the user's profile; the playing habits collected and stored in the user's profile; the average amount of time to play the game(s) on the interactive machine 100; the average amount of time it takes the user to play the game(s) on the interactive machine 100 based on the user's playing habits collected and stored in the user's profile; the time of day it is; the time of day that is peak usage for the interactive machine 100; the average amount of time the user interacts with the interactive machine 100 in a given sitting; if the user has used the at least one service alert 174; the food and/or drink(s) ordered by the user using the at least one service alert 174; the average amount of time to provide the user with the food and/or drink(s) ordered given how busy the establishment is; if the user has elected to “cash out”; the popularity of the interactive machine 100 within the establishment; the number of free plays available to the user; the amount of credits or money earned by the user by interacting with the interactive machine 100; the average power consumption to play a single game on the interactive machine 100; the current power level within the at least one first power source 178; and/or various other establishment operational data collected.

If the control unit 116, the power source control unit 184, and/or the main controller or cloud based control unit 120 determines that, based on the above provided factors, the amount of time the user is predicted to interact with the interactive machine 100 and the predicted amount of power needed to operate the interactive machine 100 for that time is less than the power level of the at least one first power source 178, then in step 506 the machine enters into the low power mode. Once entered into the low power mode, in step 508 the at least one first power source 178 supplies the power needed to operate the interactive machine 100.

In the event that the control unit 116, the power source control unit 184, and/or the main controller or cloud based control unit 120 determines that, based on the above provided factors, the amount of time the user is predicted to interact with the interactive machine 100 and the predicted amount of power needed to operate the interactive machine 100 for that time is more than the power level of the at least one first power source 178, then in step 510 the machine enters into the high power mode. Once entered into the high power mode, in step 512, the at least one second power source 182 supplies the power needed to operate the interactive machine 100.

Once the interactive machine 100 has entered into the low power mode or the high power mode, the control unit 116, the power source control unit 184, and/or the main controller or cloud based control unit 120, in step 514, may monitor the usage of the interactive machine 100. It is within the scope of this disclosure and as a non-limiting example that the control unit 116, the power source control unit 184, and/or the main controller or cloud based control unit 120 may continuously monitor or may monitor the usage of the interactive machine 100 at pre-determined intervals.

The control unit 116, the power source control unit 184, and/or the main controller or cloud based control unit 120, in step 516, may also monitor the amount of power within the at least one power sources 178. It is within the scope of this disclosure and as a non-limiting example that the control unit 116, the power source control unit 184, and/or the main controller or cloud based control unit 120 may continuously monitor or may monitor the power level within the at least one first power source 178 at pre-determined intervals.

Periodically, after the interactive machine 100 has entered into the low power mode or the high power mode, the control unit 116, the power source control unit 184, and/or the main controller or cloud based control unit 120, in step 518 and/or step 526, may make at least one subsequent determination. The at least one subsequent determination may be based on the above provided factors, if the amount of time the user is predicted to interact with the interactive machine 100 and the predicted amount of power needed to operate the interactive machine 100 for that time is more or less than the power level within the at least one first power source 178, then the machine will enter into the high power mode or the low power mode, respectively.

In the event that the interactive machine 100 transitions from the low power mode to the high power mode, in step 520, the power system 176 stops supplying power with the at least one first power source 178 and, in step 522, then supplies the interactive machine 100 with power via the at least one second power source 182. While in the high power mode 510, the control unit 116, the power source control unit 184, and/or the main controller or cloud based control unit 120, in step 524, may instruct the power system 176 to supply the at least one first power source 178 with an amount of power to charge the at least one first power source 178.

In contrast, if the interactive machine 100 transitions from the high power mode to the low power mode, in step 528, the power system 176 stops supplying power with the at least one second power source 178 and, in step 530, then supplies the interactive machine 100 with power via the at least one first power source 182. While in the low power mode, the control unit 116, the power source control unit 184, and/or the main controller or cloud based control unit 120, in repeat step 524, may instruct the power system 176 to supply the at least one first power source 178 with an amount of power to charge the at least one first power source 178. This aids in increasing the overall amount of time the user can interact with the interactive machine 100 without having to transition from the low power mode to the high power mode.

It is to be understood that while the power system 176 is switching between using the at least one first power source 178 and using the at least one second power source 182 as the primary power source for the interactive machine 100, there may be a period where both the first and second power sources 178, 182, respectively, are both supplying power to the interactive machine 100. This aids in ensuring that the interactive machine 100 always has an amount of power needed to operate the interactive machine 100 in an uninterrupted manner. The steps 504 through 530 may be repeated until the interactive machine 100 is no longer in use.

In light of the foregoing, the interactive machine 100, the power system 176, and the method of operation 500 the power system 176 described and illustrated herein reduces the overall drain or strain the establishment puts on the power grid and therefore reduces the overall amount of power consumption by the establishment. Additionally, in light of the foregoing, it is therefore to be understood that the power system 176 and the method of operation 500 the power system 176 described and illustrated herein aids in reducing the overall costs associated with the operation of the interactive machine 100. Furthermore, the in light of the foregoing, it is therefore to be understood that the interactive machine 100, the power system 176, and/or and the method of operation 500 the power system 176 may be adaptive thereby reducing the overall costs and power consumption associated with the interactive machine 100.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to from the inventive concepts defined in the appended claims.

In accordance with the provisions of the patent statutes, the present subject matter has been described to represent what is considered to represent the preferred embodiments. However, it should be noted that this subject matter can be practiced in other ways than those specifically illustrated and described without departing from the spirit or scope of this subject matter.

What is claimed is:

1. A machine, comprising:
at least one user interface;
at least one user input device configured to permit a user to interact with the machine; and
a power system having at least one first power source and at least one second power source, wherein at least one of the at least one first power source and the at least one second power source is configured to provide power to the machine.

2. The machine of claim 1, wherein the machine is one of a gambling machine, a casino game machine, a video poker machine, a slot machine, a video slot machine, a gambling kiosk machine, a redemption machine, a note breaker machine, a video gambling machine, an arcade machine, an arcade game machine, a kiosk machine, a vending machine, and an automated teller machine.

3. The machine of claim 1, wherein the machine further comprises a control unit.

4. The machine of claim 3, wherein the control unit of the machine is in communication with at least one of a main controller and a cloud based control unit.

5. The machine of claim 1, wherein the machine further comprises at least one of at least one audible device, at least one visual indicator, at least one article dispensing device, an article generator, an article dispenser, a coin dispenser, and at least one receiving device.

6. A method of operation of a machine, comprising:
providing a machine including at least one user interface and a power system, the power system including at least one first power source and at least one second power source;
supplying the machine with an amount of power from the at least one first power source; and
supplying the at least one first power source with an amount of power from the at least one second power source to recharge the at least one first power source.

7. The method of claim 6, wherein the at least one first power source is at least one of at least one electro-chemical cell, at least one battery, at least one rechargeable battery, at least one lithium-ion battery, at least one secondary cell, and at least one rechargeable device.

8. The method of claim 6, wherein the at least one second power source is at least one of at least one solar power source and an electrical grid.

9. The method of claim 6, further comprising identifying an amount of power within the at least one first power source.

10. The method of claim 6, further comprising supplying the machine with an amount of power from the at least one second power source.

11. The method of claim 6, further comprising monitoring a power within the at least one first power source.

12. The method of claim 7, further comprising discontinuing supplying the machine with the amount of power from the at least one first power source once the power within the at least one first power source is below a pre-determined level.

13. The method of claim 1, further comprising discontinuing supplying the at least one first power source with the amount of power from the at least one second power source once the at least one first power source is supplied with a pre-determined amount of power.

14. The method of claim 1, further comprising operating the machine for a pre-determined amount of time using only the at least one first power source.

15. The method of claim 1, further comprising determining a percentage of power provided by the at least one first power source to power the machine.

16. The method of claim 15, further comprising determining a percentage of power provided by the at least one second power source to power the machine.

17. The method of claim 16, further comprising supplying the machine with an amount of power based on the percentage of power provided by the at least one first power source and the percentage of power provided by the at least one second power source.

18. A method of operation of a machine, comprising:
providing a machine including at least one user interface and a power system, the power system including at least one first power source and at least one second power source;
determining if the machine is in one of a high power mode and a low power mode;
entering into one of the high power mode and the low power mode;
supplying the machine with power from the at least one first power source when the machine is in the low power mode; and
supplying the machine with power from the at least one second power source when the machine is in the high power mode.

19. The method of claim 18, further comprising monitoring an amount of power within the at least one first power source.

20. The method of claim 18, further comprising determining if the machine should be one of switched from the low power mode to the high power mode and switched from the high power mode to the low power mode.
